(19) United States
(12) Patent Application Publication
(10) Pub. No.: US 2007/0260609 A1
(43) Pub. Date: Nov. 8, 2007

(54) System and method for high throughput with remote storage servers

(76) Inventor: Akhil Tulyani, Secaucus, NJ (US)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/606,334

(22) Filed: Nov. 28, 2006

Related U.S. Application Data
(60) Provisional application No. 60/740,380, filed on Nov. 28, 2005.

(51) Int. Cl. G06F 17/30

(52) U.S. Cl. 707/10; 707/E17.032

(57) ABSTRACT

A server storage infrastructure that provides a high throughput service for client machines accessing the server storage infrastructure. In preferred implementations, a file is fragmented into multiple file portions. Each of the multiple file portions is saved on separate storage servers of a storage server cluster. Fragmentation layout metadata is generated that describes the location in the storage server cluster and content of each of the multiple file portions. In response to a request from a client to one storage server of the storage server cluster, the multiple file portions are accessed from the separate storage servers from one storage server according to the fragmentation layout metadata.

### CROSS REFERENCE TO RELATED APPLICATIONS

This application claims the priority of U.S. Provisional Application for Patent Ser. No. 60/740,380, filed Nov. 28, 2005, Entitled, “System and Method for High Throughput with Remote Storage Servers”, the disclosure of which is incorporated here in its entirety.

### BACKGROUND

This disclosure relates generally to computer-based mechanisms for data storage, and more particularly to techniques for high-throughput data storage.

Typical Open Source or off-the-shelf clients are not able to realize high throughput rates over standard Ethernet networks. This is because such clients such as Windows do not lend themselves to client modification for parallel file access.

### SUMMARY

In general, this document discusses a system and method for a server storage infrastructure that provides a high throughput service for client machines accessing the storage infrastructure.

In one implementation, a method for storing and accessing data is disclosed. The method comprises fragmenting a file into multiple file portions, and saving each of the multiple file portions on separate storage servers of a storage server cluster. The method further includes generating fragmentation layout metadata that describes the location in the storage server cluster and content of each of the multiple file portions.

In another implementation, a method of storing and accessing data includes fragmenting a file into multiple file portions, saving each of the multiple file portions on separate storage servers of a storage server cluster, generating fragmentation layout metadata that describes the location in the storage server cluster and content of each of the multiple file portions, and in response to a request from a client to one storage server of the storage server cluster, accessing the multiple file portions from one storage server according to the fragmentation layout metadata.

In yet another implementation, a system includes a cluster of separate storage servers connected in a network file system, at least one of the storage servers configured to fragment a file into multiple file portions for being saved on the separate storage servers of the storage server cluster, the one storage server further configured to generate fragmentation layout metadata that describes the location in the storage server cluster and content of each of the multiple file portions, the fragmentation layout metadata comprising a global namespace for the file.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a storage server architecture.

FIG. 2 illustrates a fragmentation process for catalog metadata.

FIG. 3 illustrates a request process for a fragmented file.

FIG. 4 illustrates a process of receiving multiple concurrent requests from a client.

FIG. 5 illustrates a file retrieval and reassembly process.

Like reference symbols in the various drawings indicate like elements.

### DETAILED DESCRIPTION

This document describes a server storage infrastructure that provides a high throughput service for client machines accessing the server storage infrastructure. This service is provided and maintained over multiple servers and can be leveraged by heterogeneous clients using standardized software protocols such as Network File System (NFS), Common Internet File System (CIFS), File Transfer Protocol (FTP), etc., over off-the-shelf low-priced network hardware. The resulting bandwidth is comparable to that achieved using expensive Storage Area Networks (SANs).

In some implementations, a system and method includes a global namespace to all data provided by the server storage infrastructure. The server storage infrastructure maintains and exports a specialized file service. The specialized file service contains data that allows heterogeneous client machines to access files in parallel over multiple low cost Ethernet based network hardware thereby allowing clients to realize high throughput rates.

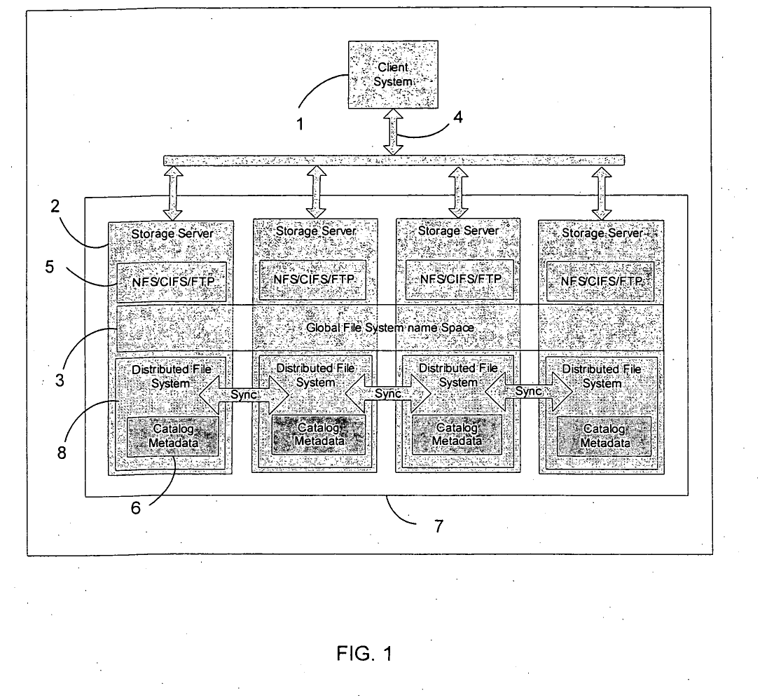

As illustrated in FIG. 1, a cluster 7 of storage servers 2 expose a single global file name space 3 to client systems 1 via NFS, CIFS, and/or FTP network file system protocol 5 over Ethernet 4. This allows any client system 1 to access any storage server 2 in the cluster 7 and retrieve a file that is visible in the global file system name space 3.

Metadata that maps file data to its virtual global name is stored in a file residing in an open source distributed file system 8 hosted by each storage server 2 in the cluster 7. This metadata will be referred to as Catalog metadata 6. The Catalog metadata 6 contains information about files stored in the global file name space 3 such as:

i. logical name space location of the file

ii. storage server locations where the physical data of the file are stored

iii. access rights

iv. activity pattern

v. compression state

vi. fragmentation layout

vii. coalesced or not

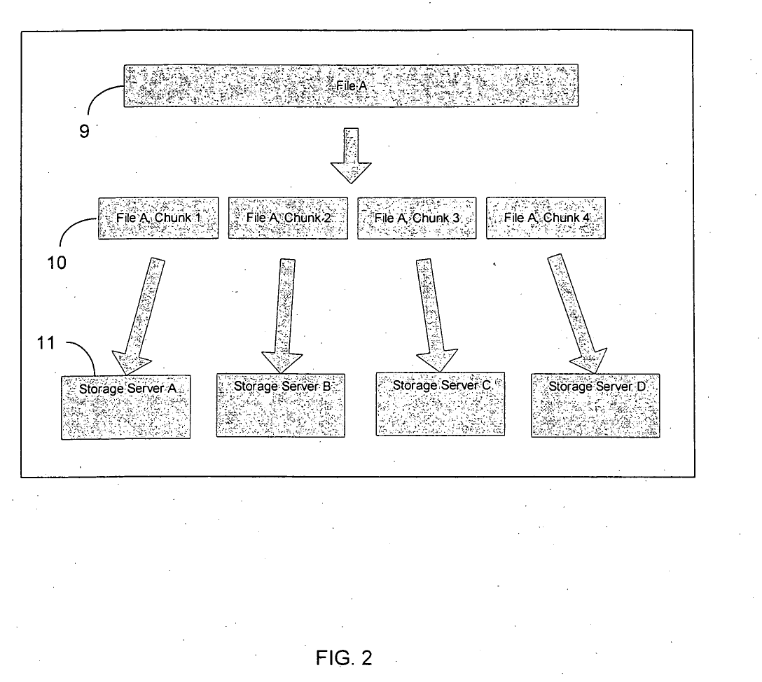

For fragmentation layout, as illustrated in FIG. 2, a file 9 can be broken up or fragmented into multiple file portions 10 (i.e. “chunks”) that are each saved onto separate storage servers 11 for increased redundancy and/or increased access performance. Each file portion 10 contains a fraction of a file 9 and can be arranged in any order to meet its reliability, accessibility, and performance requirements. File portions 10 can be contiguous sections of the file 9 or can be interleaved with one or more other file portions 10.

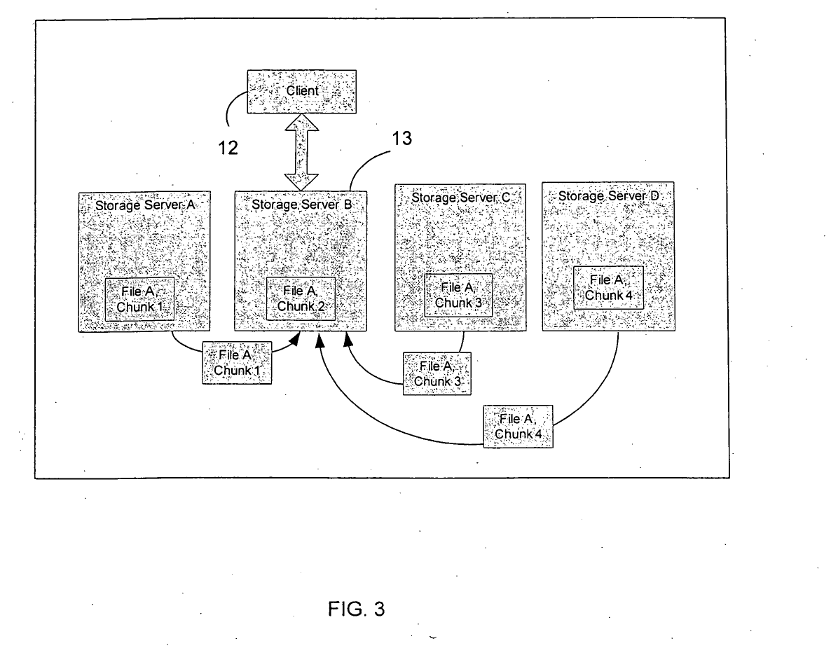

As illustrated in FIG. 3, when a storage server 13 receives a request to access a fragmented file, the server uses the information in the fragmentation layout metadata to locate and reassemble the file for the client 12. This allows storage servers 13 to access files at high bandwidth. The Catalog metadata can be made accessible to client systems 12 by securely accessing the distributed file system through a standard network file system interface like NFS, CIFS, or FTP or the like.

In exemplary implementations, client systems may make requests to access a file from any storage server. When a storage server receives a file access request from a client system, the storage server determines which storage server has the file's physical data and initiates a request to that storage server. If a file is fragmented across several storage servers, then multiple concurrent access requests are sent to all the storage servers that contain a fragment of the file. This greatly increases the bandwidth performance of accessing files between storage servers.

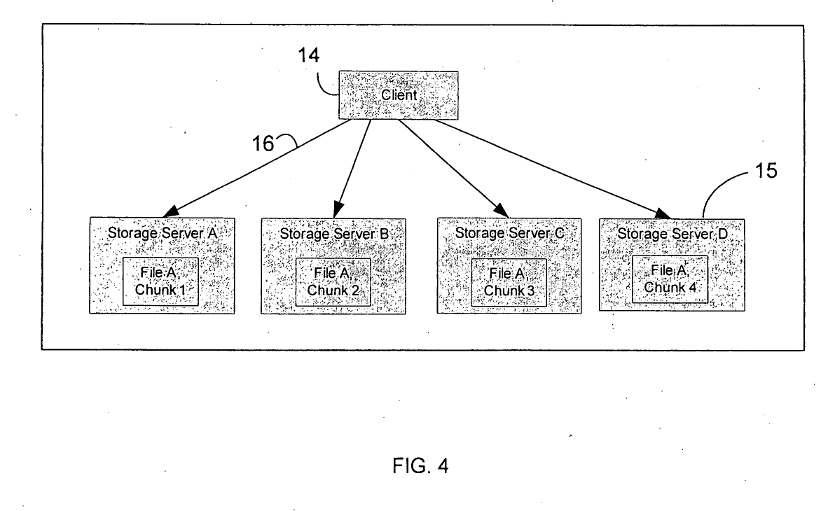

Clients can also achieve high bandwidth performance by using software that accesses the Catalog metadata stored in any one of the storage servers. As illustrated in FIG. 4, to achieve high bandwidth, a client 14 will read the fragmentation layout metadata of a file of interest from any one of the storage servers 15 in a cluster. The fragmentation layout metadata will tell the client which storage servers contain pieces of the file. The client 14 will also initiate multiple concurrent requests 16 to the storage servers 15 that have fragments of the required file.

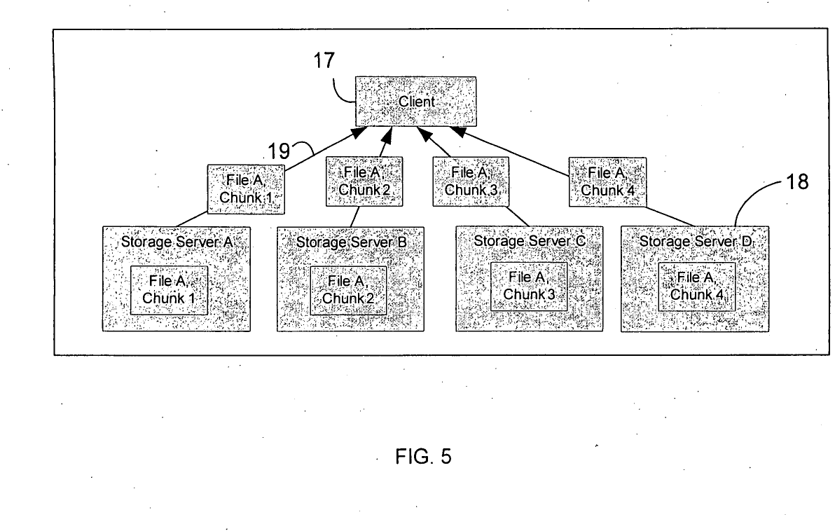

As illustrated in FIG. 5, the client 17 then retrieved file portions 19 from the storage servers 18 and then reassembles the into a single contiguous file buffer. This client code is similar to that of the storage server when it fetches fragmented files from multiple servers, but with the exception that the clients do not have to synchronize the metadata across multiple storage servers in the cluster. Accordingly, this “fetch and assemble” code is highly portable to almost any client platform.

Implementations of a client machine and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A method of storing and accessing data, the method comprising:
fragmenting a file into multiple file portions;
saving each of the multiple file portions on separate storage servers of a storage server cluster; and
generating fragmentation layout metadata that describes the location in the storage server cluster and content of each of the multiple file portions.

2. A method in accordance with claim 1, wherein the fragmentation layout metadata includes a global namespace provided to the file by the storage server cluster.

3. A method in accordance with claim 1, wherein the multiple file portions are contiguous sections of the file.

4. A method in accordance with claim 1, wherein the multiple file portions are interleaved sections of the file.

5. A method in accordance with claim 1, further comprising receiving, at one storage server of the storage server cluster, a request from a client for the file.

6. A method in accordance with claim 5, wherein the request is received via a standard network file system interface.

7. A method in accordance with claim 5, further comprising accessing and assembling the multiple file portions in the one storage server of the storage server cluster according to the fragmentation layout metadata.

8. A method in accordance with claim 7, wherein the accessing the multiple file portions is based on the global namespace.

9. A method in accordance with claim 5, further comprising forwarding the request from the one storage server to other storage servers of the storage server cluster based on the location of each of the multiple file portions of the requested file.

10. A method in accordance with claim 7, wherein the assembling the multiple file portions includes assembling each of the multiple file portions in a continuous buffer in the one storage server.

11. A method of storing and accessing data, the method comprising:
fragmenting a file into multiple file portions;
saving each of the multiple file portions on separate storage servers of a storage server cluster;
generating fragmentation layout metadata that describes the location in the storage server cluster and content of each of the multiple file portions;
in response to a request from a client to one storage server of the storage server cluster, accessing the multiple file portions from one storage server according to the fragmentation layout metadata.

12. A method in accordance with claim 11, wherein the fragmentation layout metadata includes a global namespace provided to the file by the storage server cluster.

13. A method in accordance with claim 11, wherein the multiple file portions are contiguous sections of the file.

14. A method in accordance with claim 11, wherein the multiple file portions are interleaved sections of the file.

15. A method in accordance with claim 11, wherein the request from the client is received via a standard network file system interface.

16. A method in accordance with claim 15, wherein the standard network file system interface is selected from the protocol group consisting of NFS, CIFS, or FTP.

17. A method in accordance with claim 1, wherein the accessing the multiple file portions is based on the global namespace.

18. A method in accordance with claim 11, further comprising forwarding the request from the one storage server to other storage servers of the storage server cluster based on the location of each of the multiple file portions of the requested file.

19. A method in accordance with claim 18, further comprising assembling the multiple file portions in a continuous buffer in the one storage server.

20. A system for storing and accessing data, the method comprising:
a cluster of separate storage servers connected in a network file system, at least one of the storage servers configured to fragment a file into multiple file portions for being saved on the separate storage servers of the storage server cluster, the one storage server further configured to generate fragmentation layout metadata that describes the location in the storage server cluster and content of each of the multiple file portions, the fragmentation layout metadata comprising a global namespace for the file.
